(19) United States
(12) Patent Application Publication
(10) Pub. No.: US 2017/0001889 A1
(43) Pub. Date: Jan. 5, 2017

(54) MICRO-ENCAPSULATING FLOCCULATING DISPERSION WATER TREATMENT SYSTEM

(71) Applicant: CoResource Solutions, LLC, Abilene, TX (US)

(72) Inventor: Ian Ireland, Regina (CA)

(21) Appl. No.: 15/200,233

(22) Filed: Jul. 1, 2016

Related U.S. Application Data
(60) Provisional application No. 62/187,579, filed on Jul. 1, 2015.

(51) Int. Cl. C02F 1/52; C02F 3/00; C02F 1/28; C02F 1/66; C02F 1/02

(52) U.S. Cl. CPC C02F 1/5281; C02F 1/66; C02F 1/5245; C02F 1/02; C02F 1/28; C02F 3/00; C02F 2101/32

(57) ABSTRACT

A system for continuously treating water with residual oil and/or solids includes a treatment system with inline mixers. A pH adjustment fluid may be added to the water in a first inline mixer. A micro-encapsulating flocculating dispersion flocculant may be added in a second inline mixer. The addition of the micro-encapsulating flocculating dispersion flocculant may cause flocculation of residual oil and/or solids in the water to form a pin flocculant. An activator may be added in a third inline mixer and a conditioner may be added in a fourth inline mixer. Bulk flocculant may be formed from the pin flocculant after the addition of the conditioner. The resultant mixture may flow to a settling tank where the flocculants may settle to produce treated water. After settling, the treated water may flow through a mechanical filter and/or a sorption filter to produce water suitable for desalination and/or other downstream processes.

### PRIORITY CLAIM

This patent claims priority to U.S. Provisional Patent Application No. 62/187,579 to Ireland et al., entitled “MICRO-ENCAPSULATING FLOCCULATING DISPERSION WATER TREATMENT SYSTEM”, filed Jul. 1, 2015, which is incorporated by reference in its entirety as if fully set forth herein.

### BACKGROUND

1. Field of the Invention

The present invention relates to a water treatment system. More particularly, the invention relates to a system for removing residual oil and solids from water produced as a by-product of oil and gas production.

2. Description of Related Art

Water is often produced along with oil and/or gas in many oil and gas production processes. The water is separated from the oil or gas so that the oil or gas can be sent for downstream processing and the water becomes a by-product of the oil or gas production process (e.g., produced water). The produced water, however, often has residual oil and/or solids that are not easily separated from the water. For example, the produced water may have residual oil, oily micelles, dissolved organic compounds, dissolved organic salts, iron sulfides, iron oxides, scale, and/or particulates of sand or clay. Thus, the produced water must be further treated to remove these residual products so that the water can be recycled, surface released, or sold.

Typical produced water treatment processes include the use of flocculants, coagulants, micro-bubble flotation, inclined plate separation, coalescing plate media, media bed filtration, bag filtration, organic membrane separation, and centrifugal separation. In some processes, one or more of these methods may be combined for water treatment. These processes may, however, be time consuming, ineffective, labor intensive and costly. They are often batch processes that require long process periods for mixing of additives to the produced water and/or settling of residual components out of the water (to produce treated water) or they require high levels of maintenance to remain operational. In addition, the use of fixed size equipment does not allow the size and/or throughput of these systems to be varied without significant redesign of the system and expensive capital equipment costs (e.g., different sized tanks).

### SUMMARY

In certain embodiments, a system for treating water with residual oil and/or solids includes a tank for storing untreated water comprising residual oil and/or solids. Piping may be coupled to the tank. The piping may propagate a flow of the untreated water from the tank. A first inline mixer may be located on the piping. A pH adjustment fluid may be added to the flow of water in the first inline mixer to adjust a pH of the flow of water. A second inline mixer may be located on the piping downstream of the first inline mixer. The second inline mixer may add a micro-encapsulating flocculating dispersion flocculant to the flow of water. The addition of the micro-encapsulating flocculating dispersion flocculant may cause flocculation of residual oil and/or solids in the water to form a pin flocculant. A third inline mixer may be located on the piping downstream of the second inline mixer. The third inline mixer may add an activator to the flow of water. A fourth inline mixer may be located on the piping downstream of the third inline mixer. The fourth inline mixer may add a conditioner to the flow of water. A settling tank may be coupled to the piping downstream of the fourth inline mixer. The settling tank may collect water flowing into the settling tank from the piping and allow flocculants (bulk and/or pin) to settle out from the collected water to produce separated treated water and flocculant in the settling tank.

In certain embodiments, a method for treating water with residual oil and/or solids includes providing a flow of untreated water, the untreated water including residual oil and/or solids, into piping with at least four inline mixers located in series on the piping. If necessary, a pH adjustment fluid may be added to the flow of untreated water in a first inline mixer. A micro-encapsulating flocculating dispersion flocculant may be added to the flow of water in a second inline mixer to form a pin flocculant in the flow of water. If necessary, an activator may be added to the flow of water in a third inline mixer. A conditioner may be added to the flow of water in a fourth inline mixer to form a bulk flocculant in the flow of water. The flow of water may be provided to a settling tank. The bulk flocculant and/or the pin flocculant may be allowed to settle from the water in the settling tank.

In certain embodiments, a method for treating water produced as a by-product of an oil or gas production process includes providing a flow of untreated water, the untreated water including residual oil, into piping with at least four inline mixers located in series on the piping. If necessary, a pH adjustment fluid is added to the flow of untreated water in a first inline mixer. A micro-encapsulating flocculating dispersion flocculant may be added to the flow of water in a second inline mixer to form a pin flocculant in the flow of water. If necessary, an activator may be added to the flow of water in a third inline mixer. A conditioner may be added to the flow of water in a fourth inline mixer to form a bulk flocculant in the flow of water. The flow of water may be provided to a settling tank. The flow of water may include at least some residual oil. The bulk flocculant and/or the pin flocculant may be allowed to settle from the water in the settling tank. At least some of the bulk flocculant and/or the pin flocculant may form a layer separating at least some of the residual oil from the water. The oil may be removed from the settling tank.

### BRIEF DESCRIPTION OF THE DRAWINGS

Features and advantages of the methods and apparatus of the present invention will be more fully appreciated by reference to the following detailed description of presently preferred but nonetheless illustrative embodiments in accordance with the present invention when taken in conjunction with the accompanying drawings in which:

FIG. 1 depicts a representation of an embodiment of a process system for treating water produced as a by-product of an oil or gas production process.

FIG. 2 depicts a representation of an embodiment of a process system for treatment of treated water from a settling tank.

FIG. 3 depicts a representation of an embodiment of a process system with desalination for secondary water processing.

FIG. 4 depicts a representation of an embodiment of a process system with biological wastewater treatment for secondary water processing.

FIG. 5 depicts a representation of an embodiment of a process system with water reuse instead of a secondary water process.

FIG. 6 depicts a representation of an embodiment of a process that may be used for oil and water separation.

While the invention is susceptible to various modifications and alternative forms, specific embodiments thereof are shown by way of example in the drawings and will herein be described in detail. The drawings may not be to scale. It should be understood that the drawings and detailed description thereto are not intended to limit the invention to the particular form disclosed, but to the contrary, the intention is to cover all modifications, equivalents and alternatives falling within the spirit and scope of the present invention as defined by the appended claims.

The headings used herein are for organizational purposes only and are not meant to be used to limit the scope of the description. As used throughout this application, the word “may” is used in a permissive sense (i.e., meaning having the potential to), rather than the mandatory sense (i.e., meaning must). The words “include,” “including,” and “includes” indicate open-ended relationships and therefore mean including, but not limited to. Similarly, the words “have,” “having,” and “has” also indicated open-ended relationships, and thus mean having, but not limited to. The terms “first,” “second,” “third,” and so forth as used herein are used as labels for nouns that they precede, and do not imply any type of ordering (e.g., spatial, temporal, logical, etc.) unless such an ordering is otherwise explicitly indicated. For example, a “third inline mixer” does not preclude scenarios in which a “fourth inline mixer” is connected prior to the third inline mixer, unless otherwise specified. Similarly, a “second” feature does not require that a “first” feature be implemented prior to the “second” feature, unless otherwise specified.

Various components may be described as performing a task or tasks, for convenience in the description. Such descriptions should be interpreted as including the phrase “configured to.” Reciting a component that is configured to perform one or more tasks is expressly intended not to invoke 35 U.S.C. §112 paragraph (f), interpretation for that component.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims

### DETAILED DESCRIPTION OF EMBODIMENTS

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

In the context of this patent, the term “coupled” means either a direct connection or an indirect connection (e.g., one or more intervening connections) between one or more objects or components. The phrase “directly connected” means a direct connection between objects or components such that the objects or components are connected directly to each other so that the objects or components operate in a “point of use” manner.

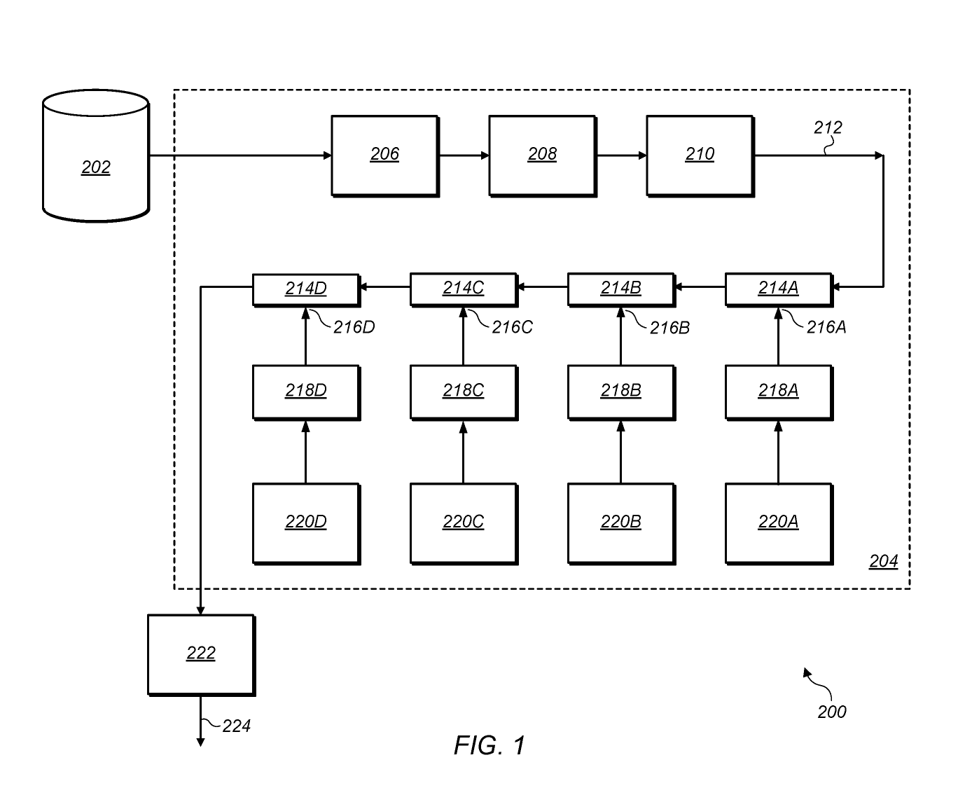

FIG. 1 depicts a representation of an embodiment of a process system for treating water produced as a by-product of an oil and/or gas production process. In certain embodiments, process system 200 includes storage tank 202. Tank 202 may be used to store untreated water produced as a by-product of an oil and/or gas production process. In some embodiments, the untreated water is water separated from oil and/or gas in fluids produced from the oil and/or gas production process. In some embodiments, the untreated water includes residual oil and/or solids left after separation of the water from the oil and/or gas.

In certain embodiments, the untreated water has a residual oil and/or solids concentration up to a selected value. For example, the untreated water may have an oil cut of up to about 40% (e.g., between 0% and 40%). In some embodiments, the untreated water has a salinity concentration between 0 ppm TDS (total dissolved solids) up to saturation. In some embodiments, the untreated water has a pH between 1 and 12.

Tank 202 may provide untreated water into treatment system 204. In certain embodiments, treatment system 204 is used to continuously treat the untreated water with residual oil and/or solids. In some embodiments, tank 202 stores untreated water until a selected water level is reached in the tank. For example, tank 202 may include at least one level switch trigger that opens a valve to treatment system 204 when the selected water level in the tank is reached. The untreated water may then continuously flow into treatment system 204. In some embodiments, water fed into treatment system 204 from tank 202 passes through heat exchanger 206. Heat exchanger 206 may be used to heat or cool water entering treatment system 204 to a temperature in a selected temperature range. Thus, if the water entering treatment system 204 has a temperature below the selected temperature range, heat exchanger 206 may be used to heat the water to a temperature in the selected temperature range. Alternatively, if the water entering treatment system 204 has a temperature above the selected temperature range, heat exchanger 206 may be used to cool the water to a temperature in the selected temperature range.

In certain embodiments, the lower limit on the selected temperature range is set to inhibit water density from increasing to a point at which flocculant settles too slowly. The upper limit on the selected temperature range may be set to maintain polymer stability during flocculation and/or membrane stability for downstream systems (e.g., desalination systems). In certain embodiments, the selected temperature range is between about 10° C. and about 55° C. In some embodiments, the selected temperature range is between about 0° C. and about 60° C.

In certain embodiments, treatment system 204 includes pump 208. Pump 208 may be used to move the untreated water through treatment system 204. Pump 208 may be, for example, a single speed pump or a variable speed pump. In some embodiments, pump 208 is coupled to a flow control valve (e.g., an electronically actuated flow control valve). Pump 208 may be turned on when the flow control valve is opened. The flow control valve may be used in combination with pump 208 to provide a desired flow rate of untreated water through treatment system 204.

In certain embodiments, flow meter 210 is used to monitor the flow rate through treatment system 204. Flow meter 210 may be, for example, a turbine flow meter. Flow meter 210 may be, however, any type of flow meter that provides a signal (e.g., an electrical signal) with flow rate information. The flow rate information may be used to control feed rates of chemicals added in treatment system 204, as described below.

In certain embodiments, treatment system 204 includes piping 212 and inline mixers 214. In one embodiment, four inline mixers 214A-D are located in series along piping 212, as shown in FIG. 1. Piping 212 may be, for example, CPVC (chlorinated polyvinyl chloride) piping or another suitable material. In certain embodiments, piping 212 has a diameter between about 1″ and about 3″. For example, piping 212 may have a diameter of about 2″. The diameter of piping 212 may be adjusted as needed for different flow rates and/or production rates desired in treatment system 204.

Inline mixers 214 may be, for example, static mixers (e.g., static inline mixers) or other mixers capable of mixing additional fluids with water while water flows through the mixers. One example of a static mixer includes Koflo® model 2-80-4-6-2 (Koflo Corporation, Cary, Ill., U.S.A.). In certain embodiments, inline mixers 214 include inlet ports 216 (e.g., injection ports) for adding additional fluids to the untreated water flowing through piping 212. In one embodiment, as shown in FIG. 1, inline mixer 214A includes inlet port 216A, inline mixer 214B includes inlet port 216B, inline mixer 214C includes inlet port 216C, and inline mixer 214D includes inlet port 216D.

Inlet ports 216A-D may be coupled to pumps 218A-D. Pumps 218A-D may be, for example, chemical delivery pumps. Pumps 218A-D may be fed materials (e.g., chemicals) from storage tanks 220A-D. The size and throughput of inlet ports 216A-D, pumps 218A-D, and storage tanks 220A-D may be determined based on the volume and/or flow rate of water through treatment system 204.

In certain embodiments, the untreated water has a pH that is too low or too high and the pH needs adjustment. First inline mixer 214A may be used to adjust the pH of untreated water flowing through piping 212. A pH adjustment fluid may be provided to inlet port 216A and added to the water flowing through inline mixer 214A. In embodiments where the pH is too low (e.g., too acidic), the pH adjustment fluid may be, for example, sodium hydroxide (NaOH) or caustic NaOH. Caustic NaOH may be, for example, 25% or 50% NaOH. In embodiments where the pH is too high (e.g., too basic), the pH adjustment fluid may be, for example, an acid such as HCl, H₂SO₄, or H₃PO₄. In certain embodiments, first inline mixer 214A is used to adjust the pH of the untreated water to a pH between about 6.5 and about 10. In some embodiments, no adjustment of pH is necessary and no pH adjustment fluid is added at inline mixer 214A. The amount of pH adjustment fluid added and/or the desired pH level for water leaving inline mixer 214A may be adjusted as needed based on optimization of the treatment process and/or properties of the incoming untreated water.

In certain embodiments, second inline mixer 214B is used to add a first flocculant to the water flowing through the inline mixer (either untreated or pH adjusted water). The first flocculant may be added through inlet port 216B on inline mixer 214B. In certain embodiments, the first flocculant is a micro-encapsulating flocculating dispersion (MFD) flocculant. The MFD flocculant may be, for example, a nanopolymer dispersion such as described in U.S. Pat. No. 7,750,066 to Sutherland, which is incorporated by reference as if fully set forth herein.

Addition of the first flocculant (e.g., the MFD flocculant) to the water flowing through inline mixer 214B causes flocculation of residual oil and/or solids in the water. In certain embodiments, the residual oil and/or solids are formed into pin flocculant after the MFD flocculant is added into the flowing water at inline mixer 214B. Pin flocculant may include, for example, flocculant that is barely visible to the eye and in a micron range. In some embodiments, pin flocculant includes flocculant with an average diameter of between about 0.01 mm and about 0.5 mm. For example, pin flocculant may include flocculant with an average diameter of about 0.1 mm.

In certain embodiments, third inline mixer 214C is used to add an activator to the water and pin flocculant mixture flowing through the inline mixer. The activator may be added through inlet port 216C on inline mixer 214C. The activator may be, for example, a slow flocculant such as iron chloride (FeCl₂), aluminum sulfate (Al₂(SO₄)₃), or another inorganic flocculant. The activator may improve conditions for formation of bulk flocculant in fluid flowing out of inline mixer 214C. For example, if the fluid flowing through inline mixer 214C has low salinity, addition of the activator may reduce repulsive forces that inhibit bulk flocculant formation. In some embodiments, untreated water entering treatment system 204 may have high salinity content and addition of the activator may not be necessary.

In certain embodiments, fourth inline mixer 214D is used to add conditioner to the water mixture (e.g., water and pin flocculant) flowing through the inline mixer. The conditioner may be added through inlet port 216D on inline mixer 214D. In certain embodiments, the conditioner is a high molecular weight polymeric flocculant. For example, the conditioner may be AP-820 polymer flocculant (C.C.I. Chemical Corporation, Vernon, Calif.) or another flocculant that produces bulk flocculant.

In certain embodiments, the conditioner collects pin flocculant in the water mixture and forms bulk flocculant from the collected pin flocculant (e.g., the conditioner gathers together the pin flocculant, forming the bulk flocculant). The bulk flocculant may be a floating, rolling mass in the water mixture flowing through piping 212. In some embodiments, bulk flocculant includes flocculant with an average diameter of between about 1 mm and about 2.5 cm. In some embodiments, bulk flocculant includes flocculant with an average diameter between about 1 mm and about 2 cm.

In some embodiments, inline mixer 214A may be moved to adjust the pH after inline mixer 214D (e.g., inline mixer 214A becomes the last inline mixer in treatment system 204). For example, if the untreated water has a high scaling factor, the pH adjustment fluid may be added last instead of being added first. Adding the pH adjustment fluid last in such embodiments may minimize scale formation in the inline mixers and decrease maintenance requirements for treatment system 204.

In certain embodiments, the water mixture (water with bulk flocculant and any remaining pin flocculant) is provided to settling tank 222 after inline mixer 214D. In certain embodiments, the water mixture continuously flows through treatment system 204 into settling tank 222 (e.g., water flows continuously through the treatment system between storage tank 202 and settling tank 222). In some embodiments, a portion of piping 212 (e.g., portion 106A) between inline mixer 214D and settling tank 222 allows slow rolling of the flow of water between the inline mixer and the settling tank. For example, the piping portion may be sized (e.g., have a larger diameter) to allow slow rolling of the flow of water. Slow rolling of the flow of water may increase bulk flocculant formation in the flow of water after the conditioner is added.

Settling tank 222 may be any standard tank that allows settling of a flocculant mixture from water. In some embodiments, settling tank 222 is a conical settling tank. In some embodiments, settling tank 222 is a horizontal tank (e.g., a frac tank), a vertical tank, a weir tank, a floc tank, a pit, or a parallel plate separator. In certain embodiments, settling tank 222 is an API separator. One example of a settling tank is a Chem-Tainer TA4254JC (Chem-Tainer Industries, West Babylon, N.Y., U.S.A.). After the water mixture (e.g., water, bulk flocculant, and/or pin flocculant) is provided to settling tank 222, flocculant may be allowed to settle in the tank for a selected time (the bulk flocculant may rise to the surface or settle to the bottom depending on the design of the settling tank and/or the properties of the formed bulk flocculant). The selected time may be a time determined to be sufficient for settling of flocculant from the water to produce desired properties in the treated water (e.g., a settling time that is sufficiently long enough to produce treated water with desired qualities such as water purity and/or low contamination (oil or solid) levels). In certain embodiments, greater than 95% of the flocculant is removed from the treated water in settling tank 222.

The size of the bulk flocculant in the water mixture in settling tank 222 provides rapid settling of the bulk flocculant in the settling tank. For example, the bulk flocculant may rapidly rise to the surface or rapidly fall to the bottom of the water mixture due to the large size of the bulk flocculant (e.g., flocculant between about 1 mm and about 2 cm in average diameter). This rapid settling may increase the throughput of process system 200 compared to systems that produce smaller flocculant and reduces the time needed for water treatment. For example, in some embodiments, an elapsed time between when the flow of water from tank 202 into treatment system 204 begins and when settling is finished in settling tank 222 is at most about 2 hours. In some embodiments, the elapsed time is at most about 1 hour, at most about 30 minutes, at most about 15 minutes, or at most about 5 minutes. The elapsed time between introduction of water into treatment system 204 and settling in settling tank 222 may vary based on factors such as, but not limited, total water input, water flow rate, amount of residual oil and/or solid in the untreated water, amount and/or rate of flocculant addition. In some embodiments, a user of process system 200 may vary the elapsed time as desired based on, for example, treated water output desired, tank usage available, or other factors. The size of process system 200 (e.g., size of piping 212 and/or inline mixers 214) may be varied to accommodate different desired process parameters (e.g., untreated water input, process throughput, treated water output, etc.).

In some embodiments, more than one settling tank 222 is coupled to piping 212 and/or the piping may be attached to multiple settling tanks (e.g., decoupled from one settling tank and recoupled to another settling tank). Additional settling tanks may be used to provide increased throughput in process system 200. For example, after a first settling tank is filled and is in the settling phase, a second settling tank may be coupled to piping 212 and treated water supplied to the second settling tank while fluid in the first settling tank finishes settling (e.g., a multi-batch process may be used).

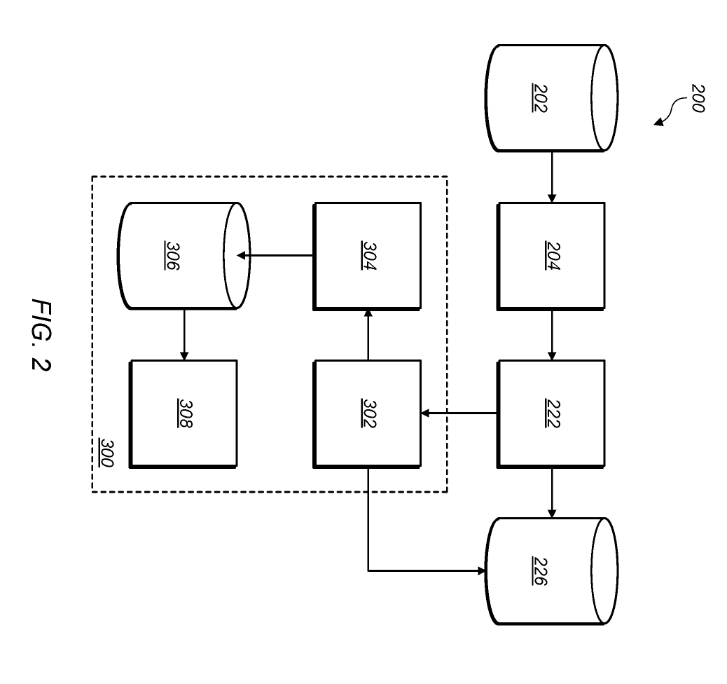

After the selected time of settling in settling tank 222, treated water is removed from the tank through piping 224. Piping 224 may provide the treated water to various different subsequent processes as described herein (e.g., process 300 depicted in FIG. 2). In some embodiments, if necessary, the pH of the treated water may be adjusted after being removed from settling tank 222. For example, the pH of the treated water may be adjusted to maintain desalination membranes used downstream in their allowable operating ranges, to improve the performance of biological wastewater treatment systems, or to maintain an optimal pH for water reuse or surface discharge.

FIG. 2 depicts a representation of an embodiment of process system 300 for treatment of treated water from settling tank 222. Process system 300 may be used downstream of settling tank 222 and treatment system 204 to further process (e.g., treat) the treated water and/or settled flocculant removed from the settling tank. In certain embodiments, settled bulk flocculant is collected and stored (for possible future use) in flocculant storage tank 226. Settled bulk flocculant may be removed from settling tank 222 using techniques known in the art.

In certain embodiments, piping 224 removes treated water from settling tank 222 and provides the treated water to process system 300. Piping 224 may first provide the treated water to mechanical filter 302 in process system 300. Mechanical filter 302 may be used to remove any residual flocculant from the treated water that was not captured in settling tank 222. The residual flocculant removed by mechanical filter 302 may be provided to flocculant storage tank 226. Mechanical filter 302 may be, for example, a Turbo-Disc filter system with back flush available from Miller-Leaman, Inc. (Daytona Beach, Fla., U.S.A.). Other examples of mechanical filters include, but are not limited to, grate filters, centrifuges, and other disc, cartridge, or bag filters. A typical filter pore size may be, for example, 30 μm but the size may vary based on specific filter applications.

After mechanical filter 302, the treated water may be provided to sorption filter 304. Sorption filter 304 may be used to remove any flocculant and/or oil that has not yet been removed from the treated water. Sorption filter 304 may be used, for example, to protect downstream equipment from contaminants in the event of any equipment failure or disruption. Sorption filter 304 may be any appropriately scaled oil sorption filter system. In some embodiments, sorption filter 304 includes a pressure cutoff to shut down the filter in the event of a system upset.

In some embodiments, treated water is provided to water storage 306 after sorption filter 304. Water storage 306 may be, for example, a water storage tank, a water pit, or a water pond. After water storage 306 (or, in some embodiments, directly from sorption filter 304, bypassing water storage 306), the treated water may be provided to secondary water processing 308. Secondary water processing 308 may include other commercially available water processing technologies. For example, secondary water processing 308 may include, but not be limited to, desalination, biological treatment, ozonation, and/or UV purification.

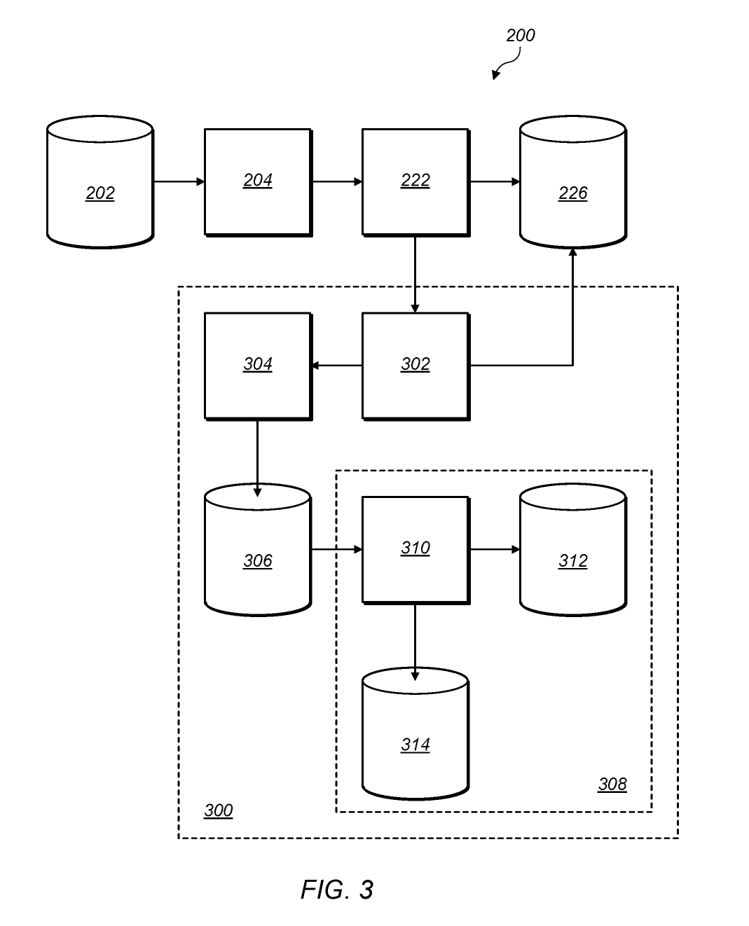

FIG. 3 depicts a representation of an embodiment of process system 300 with desalination for secondary water processing 308. Water from treated water storage 306, or water from sorption filter 304 bypassing water storage 306, may be provided to desalination system 310. Desalination system 310 may include, for example, a forward osmosis system and/or an evaporative desalination process system. Desalination system 310 may also include a reverse osmosis system and/or an evaporative pit process system. Desalination system 310 may produce desalinated water 312 and concentrated brine 314.

In certain embodiments, treatment system 204 provides treated water that is clean enough for desalination system 310 to operate without destroying membranes in the desalination system or fouling evaporators in the desalination system. Desalinated water 312 may be suitable for resuse or surface release. Concentrated brine 314 may be used for a number of potential uses depending on a concentration of the brine. The embodiment of process 200 depicted in FIG. 3 may be used on untreated water sourced from a variety of production processes. Examples of untreated water include, but are not limited to, water produced from primary oil production (including offshore production), water produced from natural gas production, water produced from coal gasification, flowback water, water from hydraulic fracturing, water from oil sands processing, water from oil pipeline cleanouts, and water from industrial sumps.

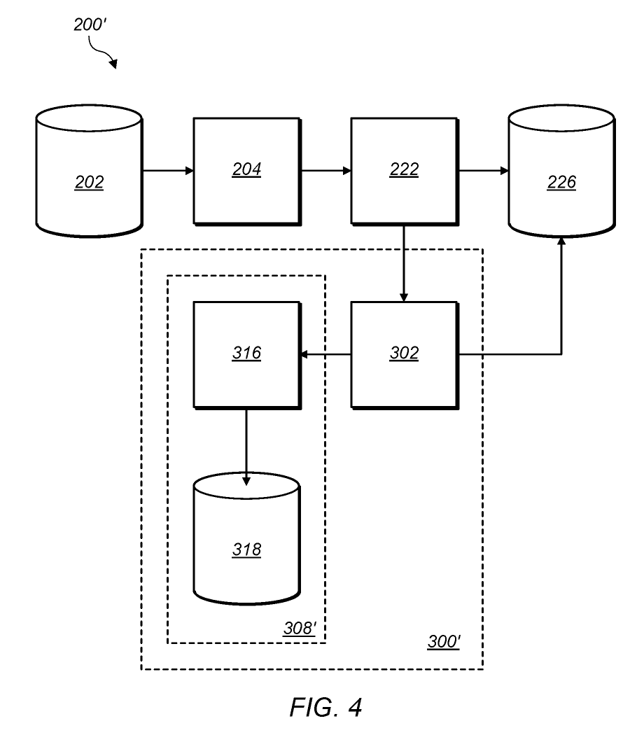

FIG. 4 depicts a representation of an embodiment of process system 300′ with biological wastewater treatment for secondary water processing 308′. The embodiment of process 200′ depicted in FIG. 4 may be used on untreated water with a high biological oxygen demand (BOD) and/or a high chemical oxygen demand (COD) in addition to high levels of residual solids and/or oils. Examples of such untreated water include, but are not limited to, landfill leachate, food processing wastewater, and agricultural wastewater. The untreated water may have, for example, a BOD level of between 0 and about 2000 and/or a COD level between 0 and about 5000 although higher BOD and/or COD levels may also be treatable using treatment system 204. Treatment system 204 may reduce both BOD and COD in the untreated water in addition to removing residual solids and/or oils.

In certain embodiments, after mechanical filter 302, the treated water is provided to biological water treatment system 316. Biological water treatment system 316 may treat the water further to make the water suitable for water reuse 318. Water reuse 318 may include surface release of the treated water and/or reuse of the treated water for another purpose. Examples of biological water treatment system 316 include, but are not limited to, engineered wetlands, bioreactors, and other ecological wastewater treatment systems. In some embodiments, as shown in FIG. 4, process system 300′ does not include sorption filter 304. Sorption filter 304 may, however, be used in some embodiments of process system 300′.

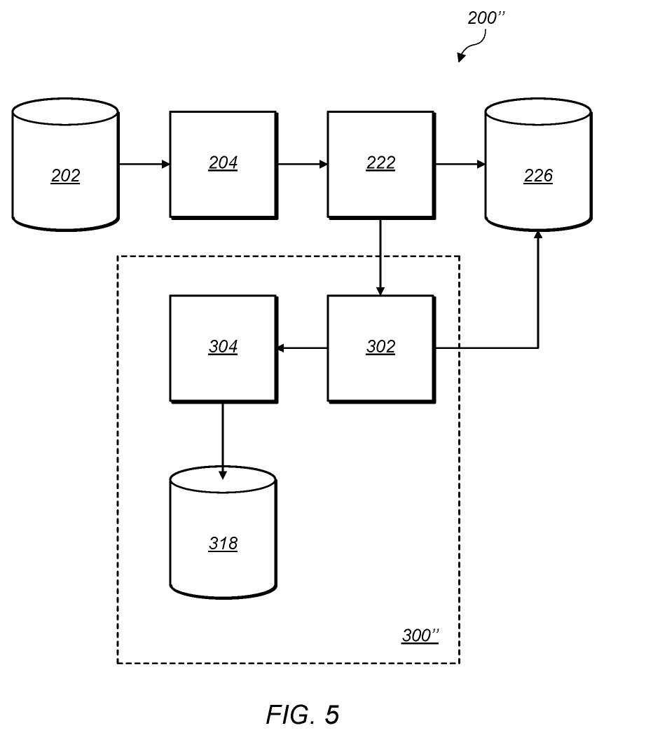

FIG. 5 depicts a representation of an embodiment of process system 300″ with water reuse 318 instead of a secondary water process. As shown in FIG. 5, after sorption filter 304, the treated water is suitable for reuse or surface release in water reuse 318 without further processing. Process system 300″ may be used when the treated water is to be released into an existing salt water body or has a low enough salinity to be suitable for surface release and/or resuse and the treated water does not contain any other contaminants above permitting levels. Examples of untreated water that may not need further treatment after treatment system 204 and settling tank 222 include, but are not limited to, water produced from primary oil production (including offshore production), water produced from natural gas production, water produced from coal gasification, flowback water, water from oil sands processing, water from oil pipeline cleanouts, bilge water, water from industrial sumps, and food processing wastewater.

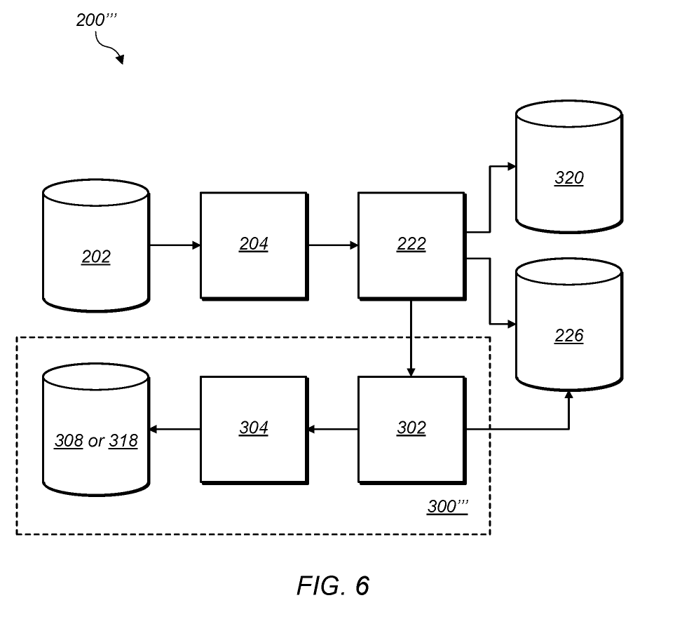

FIG. 6 depicts a representation of an embodiment of process 200′″ that may be used for oil and water separation. In certain embodiments, process 200′″ may be used to instead of traditional oilfield treaters to separate oil and water. Process 200′″ may be most suitable for treating water from primary oil production (either onshore or offshore production) but may be used for other water treatments as well. In certain embodiments, process 200′″ is used to treat water with up to about 40% oil cut in the water.

In certain embodiments, settling tank 222 in process 200′″ is an API separator. The API separator may produce a layer of free oil that may be skimmed off from the API separator and sent to oil storage 320. Flocculant may form a discrete layer between the layer of free oil and the treated water to allow the free oil to be skimmed off. The free oil layer may be pumped out periodically and provided to oil storage 320. Oil in oil storage 320 may be sold or used for other processing.

Treated water removed from the API separator (e.g., water drawn off the bottom of the API separator) may be sent to mechanical filter 302 and/or sorption filter 304 to further treat the treated water, as described above. Some or all of the “clean” water may be provided to secondary water processing 308 (e.g., desalination) and/or water reuse 318 (e.g., surface release and/or reuse). In some embodiments, at least some of the “clean” water may be pumped back into the oil-bearing formation and/or provided into an injection well.

It is to be understood the invention is not limited to particular systems described which may, of course, vary. It is also to be understood that the terminology used herein is for the purpose of describing particular embodiments only, and is not intended to be limiting. As used in this specification, the singular forms “a”, “an” and “the” include plural referents unless the content clearly indicates otherwise. Thus, for example, reference to “a mixer” includes a combination of two or more mixers and reference to “a fluid” includes mixtures of fluids.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1. A system for treating water with residual oil and/or solids, comprising:
a tank for storing untreated water comprising residual oil and/or solids;
piping coupled to the tank, wherein the piping is configured to propagate a flow of the untreated water from the tank;
a first inline mixer located on the piping, wherein the first inline mixer is configured to add a pH adjustment fluid to the flow of water in the first inline mixer to adjust a pH of the flow of water;
a second inline mixer located on the piping downstream of the first inline mixer, wherein the second inline mixer is configured to add a micro-encapsulating flocculating dispersion flocculant to the flow of water;
a third inline mixer located on the piping downstream of the second inline mixer, wherein the third inline mixer is configured to add an activator to the flow of water;
a fourth inline mixer located on the piping downstream of the third inline mixer, wherein the fourth inline mixer is configured to add a conditioner to the flow of water; and
a settling tank coupled to the piping downstream of the fourth inline mixer, wherein the settling tank is configured to collect water flowing into the settling tank from the piping, and wherein the settling tank allows flocculants to settle out from the collected water to produce separated treated water and flocculant in the settling tank.

2. The system of claim 1, wherein the untreated water is configured to be between about 0° C. and about 60° C. when the untreated water enters the first inline mixer.

3. The system of claim 1, further comprising a heat exchanger located on the piping before the first inline mixer, wherein the heat exchanger is configured to adjust a temperature of the untreated water to a temperature between about 0° C. and about 60° C.

4. The system of claim 1, wherein the pH of the water after the first inline mixer is configured to be a pH between about 6.5 and about 10.

5. The system of claim 1, wherein the micro-encapsulating flocculating dispersion flocculant comprises a nanopolymer dispersion.

6. The system of claim 1, wherein the conditioner comprises a high molecular weight polymeric flocculant.

7. The system of claim 1, wherein the micro-encapsulating flocculating dispersion is configured to form pin flocculant in the flow of water after the second inline mixer.

8. The system of claim 7, wherein the pin flocculant comprises flocculant with an average diameter of about 0.1 mm.

9. The system of claim 1, wherein at least one of the inline mixers comprises a static mixer.

10. A method for treating water comprising residual oil and/or solids, comprising:
providing a flow of untreated water, the untreated water comprising residual oil and/or solids, into piping with a series of inline mixers located on the piping;
adding, if necessary, a pH adjustment fluid to the flow of untreated water in a first inline mixer;
adding a micro-encapsulating flocculating dispersion flocculant to the flow of water in a second inline mixer to form a pin flocculant in the flow of water;
adding, if necessary, an activator to the flow of water in a third inline mixer;
adding a conditioner to the flow of water in a fourth inline mixer to form a bulk flocculant in the flow of water;
providing the flow of water to a settling tank; and
allowing the bulk flocculant and/or the pin flocculant to settle from the water in the settling tank.

11. The method of claim 10, further comprising adjusting the pH of the water after the first inline mixer to a pH between about 6.5 and about 10.

12. The method of claim 10, wherein forming the bulk flocculant by adding the conditioner comprises collecting at least some of the pin flocculant into bulk flocculant.

13. The method of claim 10, wherein the bulk flocculant comprises flocculant with an average diameter of between about 1 mm and about 2 cm.

14. The method of claim 10, further comprising allowing slow rolling of the flow of water between the fourth inline mixer and the settling tank to form the bulk flocculant in the flow of water.

15. The method of claim 10, wherein an elapsed time from providing the flow of untreated water to the bulk flocculant and/or the pin flocculant settling in the settling tank comprises less than about 60 minutes, less than about 30 minutes, less than about 15 minutes, or less than about 5 minutes.

16. The method of claim 10, further comprising removing treated water from the settling tank, wherein the treated water comprises water without a majority of the bulk flocculant and/or the pin flocculant.

17. The method of claim 10, further comprising mechanically filtering the water from the settling tank after removing the water from the settling tank.

18. The method of claim 10, further comprising sorption filtering the water from the settling tank after removing the water from the settling tank.

19. The method of claim 10, further comprising desalination the water from the settling tank after removing the water from the settling tank to produce desalinated water and brine.

20. The method of claim 10, further comprising biologically treating the water from the settling tank after removing the water from the settling tank.

21. The method of claim 10, further comprising filtering the water from the settling tank after removing the water from the settling tank, and using the water for a surface treatment operation.

22. A method for treating water produced as a by-product of an oil or gas production process, comprising:
providing a flow of untreated water, the untreated water comprising residual oil, into piping with a series of inline mixers located on the piping;
adding, if a pH of the untreated water needs adjustment, a pH adjustment fluid to the flow of untreated water in a first inline mixer;
adding a micro-encapsulating flocculating dispersion flocculant to the flow of water in a second inline mixer to form a pin flocculant in the flow of water;
adding, if necessary, an activator to the flow of water in a third inline mixer;
adding a conditioner to the flow of water in a fourth inline mixer to form a bulk flocculant in the flow of water;
providing the flow of water to a settling tank, wherein the flow of water comprises at least some residual oil;
allowing the bulk flocculant and/or the pin flocculant to settle from the water in the settling tank, wherein at least some of the bulk flocculant and/or the pin flocculant forms a layer separating at least some of the residual oil from the water; and
removing the oil from the settling tank.

23. The method of claim 22, wherein the settling tank comprises an API separator.
